(19) United States
(12) Patent Application Publication
(10) Pub. No.: US 2002/0043352 A1
(43) Pub. Date: Apr. 18, 2002

(54) Privacy screen

(76) Inventors: Gordon J. Stannis, West Olive, MI (US); Paul Dame, Holland, MI (US); Brian Matt, Wellesley Hills, MA (US); Eric Price, Medford, MA (US); Gregg Flender, Bedford, MA (US)

Correspondence Address: Timothy K. Klintworth, Brinks Hofer Gilson & Lione, P.O. Box 10395, Chicago, IL, 60610, US

(21) Appl. No.: 09/975,949

(22) Filed: Oct. 12, 2001

Related U.S. Application Data
(60) Provisional application No. 60/240,533, filed on Oct. 13, 2000.

(51) Int. Cl. B60J 3/00

(52) U.S. Cl. 160/371; 160/370.21

(57) ABSTRACT

In a preferred embodiment, a mobile privacy screen includes a support frame defining an opening, a screen member made of a flexible material, wherein the screen member is disposed across the opening and is attached the support frame at a periphery of the screen, and an outrigger extending from the support frame and having an end adapted to engage a support surface. In other embodiments, the privacy screen further comprises a wheel attached to the end of the outrigger, and the support frame further comprises a handle. A method of reconfiguring a workspace is also provided detailing the moving of the mobile privacy screen from one location to a second location.

This application claims the benefit of U.S. provisional application Ser. No. 60/240,533, filed Oct. 13, 2000, the entire disclosure of which is hereby incorporated by reference.

### BACKGROUND

The present invention relates generally to a mobile privacy screen, and to a method for use thereof.

Privacy screens of the type typically used in offices and the like typically are configured with a screen attached to a supporting frame. Such privacy screens provide the user with privacy in the work place.

Conventional privacy screens are often immobile and can be difficult to move from one position to another.

### SUMMARY

In a preferred embodiment, the privacy screen includes a support frame defining an opening, a screen member made of a flexible material, wherein the screen member is disposed across the opening and is attached to the support frame at a periphery of the screen, and an outrigger extending from the support frame and having an end adapted to engage a support surface.

In another aspect, one embodiment includes a wheel attached to the outrigger.

In yet another aspect, in one embodiment the support frame comprises a handle. In another embodiment, the handle is on a different end of the support frame than the outrigger. In yet another embodiment, the screen has an opening formed along a portion of its periphery to expose a portion of the frame whereby the exposed portion of the frame acts as a handle.

In another aspect, the support frame and the screen member define a substantially vertical plane and the outrigger extends laterally from the support frame out of the plane.

In yet another aspect, the support frame comprises a plurality of frame members extending around a periphery of the frame and defining the opening therebetween.

In another aspect, a method of reconfiguring a workspace is provided comprising: providing a privacy screen comprising a support frame defining an opening and comprising a first end and a second end, a screen member made of a flexible material, wherein the screen member is disposed across the opening and is attached to the support frame at a periphery of the screen member, and an outrigger extending from the first end of the support frame and having an end engaged with a support surface, wherein said second end of said frame is engaged with the support surface; removing the second end of the support frame from engagement with the support surface; moving the end of the outrigger engaged with the support surface from a first location to a second location; and engaging the support surface with the second end of the support frame.

In yet another aspect of the method of reconfiguring a workspace, the outrigger further comprises a wheel connected to the end thereof, wherein moving the end of the outrigger comprises rolling the wheel on the support surface.

In another aspect of the method of reconfiguring a workspace, the screen has an opening formed along a portion of its periphery to expose a portion of the frame, wherein the exposed portion of the frame defines the handle, and wherein removing the second end of the support frame comprises grasping the handle and lifting the second end of the support frame from engagement with the support surface.

The present invention provides significant advantages over other privacy screens in that it is highly mobile allowing the screen to be moved from one position to another.

The present invention, together with further objects and advantages, will be best understood by reference to the following detailed description taken in conjunction with the accompanying drawings.

### BRIEF DESCRIPTION OF THE DRAWINGS

FIG. 1 is a perspective view of a privacy screen.

FIG. 2 is a front view of the upper frame member.

FIG. 3 is a front view of a side frame member.

FIG. 4 is a front view of a second side frame member.

FIG. 5 is a perspective view of the lower frame member.

FIG. 6 is a front view of the lower frame axle connection.

FIG. 7 is a perspective view of the axle.

FIG. 8 is a perspective view of a wheel.

FIG. 9 is a front view of the flexible screen.

FIG. 10 is a cut-away front view showing the connection of a connector to two frame members.

FIG. 11 is a front view of a connector.

FIG. 12 is a perspective view of a second embodiment of a privacy screen lacking wheels.

### DETAILED DESCRIPTION OF THE PRESENTLY PREFERRED EMBODIMENTS

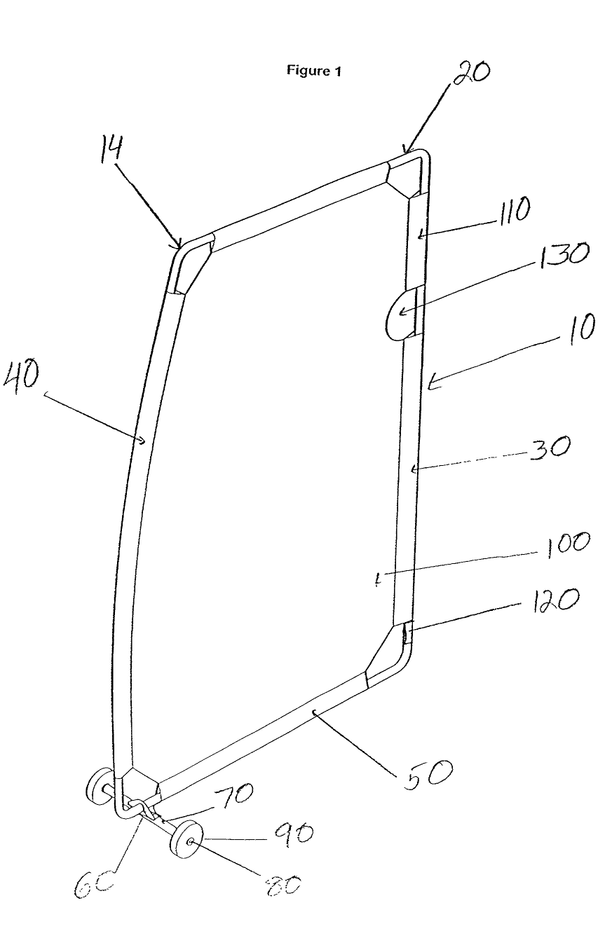

Referring to the drawings and as best shown in FIG. 1, a preferred embodiment of a privacy screen 10 includes a frame 14 having an upper frame member 20, side frame members 30 and 40, and a lower frame member 50. Further included, is an axle bracket 60, an axle 70, a threaded insert 80, wheels 90, and a flexible screen 100 having pocketed ends 110 designed to accommodate the frame 14. Also included, are connectors 120 for connecting the individual frame members, and a handle 130 comprising an opening between the screen 100 and the frame 14.

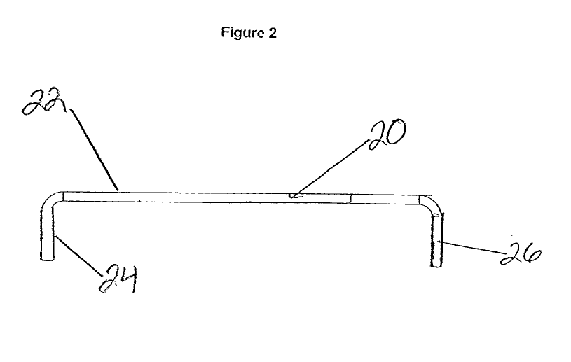

As shown in FIG. 2, the one-piece upper frame member 20 includes a horizontal portion 22 and two substantially vertical end portions 24 and 26. The frame member 20 may be solid or hollow, but is hollow at its end portions 24 and 26. The frame member is preferably steel, but may be a variety of other materials including, among others, plastic, aluminum, and fiberglass.

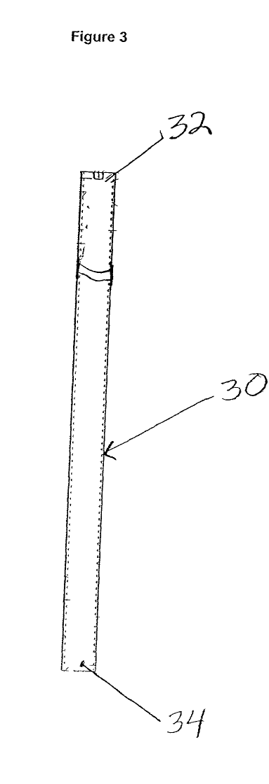

Referring to FIG. 3, the linear one-piece side frame member 30 includes a top end 32 and a bottom end 34. The frame member 30 may be solid or hollow, but is hollow at its end portions 32 and 34. The frame member is preferably steel but may be a variety of materials including, among others, plastic, aluminum, and fiberglass.

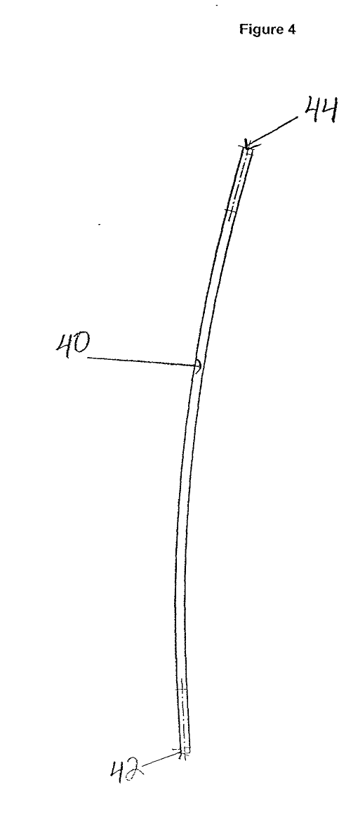

Referring to FIG. 4, the curved one-piece side frame member 40 includes a bottom end 42 and a top end 44. The frame member 40 may be solid or hollow, but is hollow at its end portions 42 and 44. The frame member is preferably steel but may be a variety of materials including, among others, plastic, aluminum, and fiberglass.

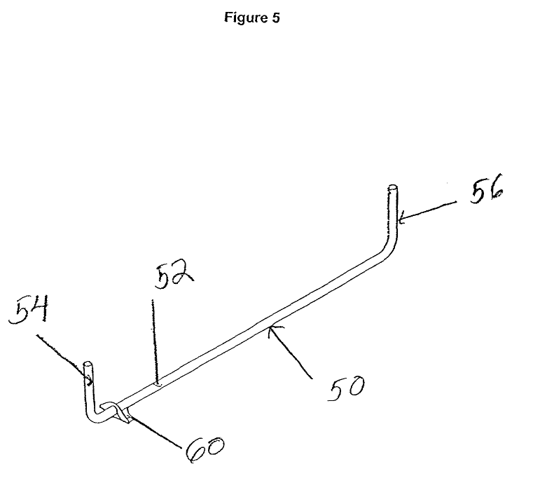

As shown in FIG. 5, the one-piece lower frame member 50 includes a horizontal portion 52 and two substantially vertical end portions 54 and 56. The frame member 50 may be solid or hollow, but is hollow at its end portions 54 and 56. The frame member is preferably steel but may be a variety of materials including, among others, plastic, aluminum, and fiberglass.

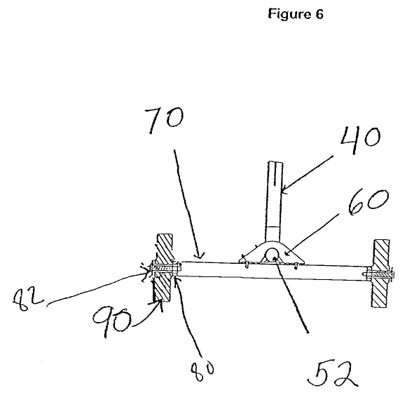

Referring to FIG. 6, welded to the horizontal portion 52 of the lower frame member 50 is an axle bracket 60 which is preferably steel but may be a variety of materials including, among others, plastic, aluminum, and fiberglass. The axle bracket 60 is bolted to a horizontal axle 70. Threaded inserts 80 are preferably pressed into each end of the horizontal axle 70. Vertical wheels 90 on each end of the axle 70 are attached to the axle 70 by threading shoulder screws 82 running through the wheels 90 into the threaded inserts 80.

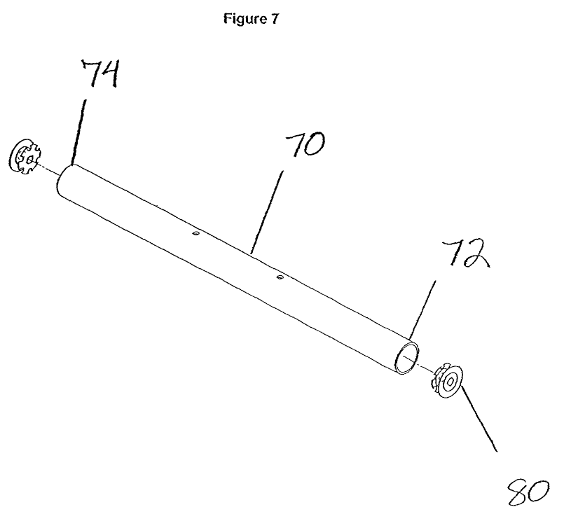

As shown in FIG. 7, the horizontal cylindrical axle 70 is one-piece and has ends 72 and 74. The axle 70 may be solid or hollow, but is hollow at each end 72 and 74 in order to insert the threaded inserts 80. The axle 70 and the threaded inserts 80 are preferably steel but may be a variety of materials including, among others, plastic.

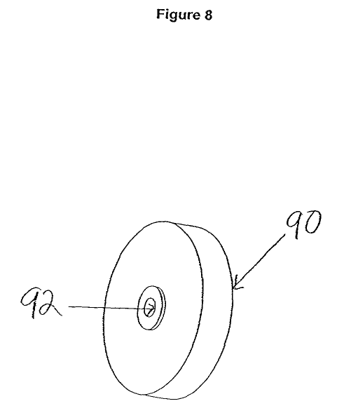

As shown in FIG. 8, the vertical wheel 90 has a centrally located through-hole 92 running horizontally completely through the entire wheel through which the shoulder screws 82 are run. The wheel 90 is preferably plastic but may be a variety of materials including, among others, steel and rubber.

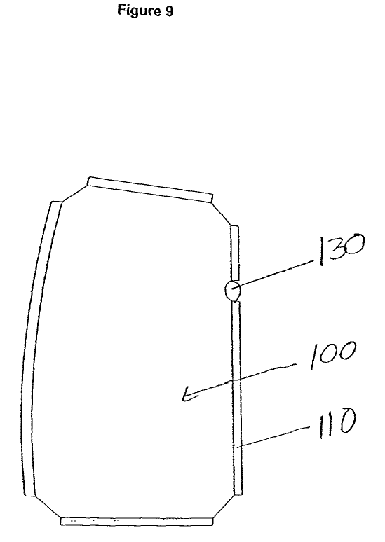

Referring to FIG. 9, the one-piece flexible screen 100 has preferably sewn end-pockets 110 running along most of its periphery. The periphery of the screen also contains some cut-away portions 130 disrupting the flow of the end-pockets 110 and acting as handles through which the frame 14 can be gripped. The screen is preferably made out of fabric but may be a variety of materials.

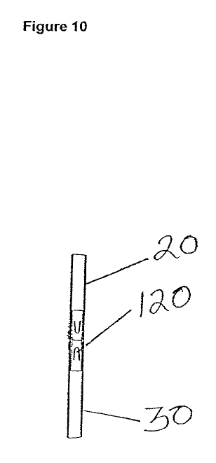

As shown in FIG. 10, connectors 120 connect each of the individual frame members 20, 30, 40, and 50 together forming a continuous frame 14 around the flexible screen 100 as shown in FIG. 1.

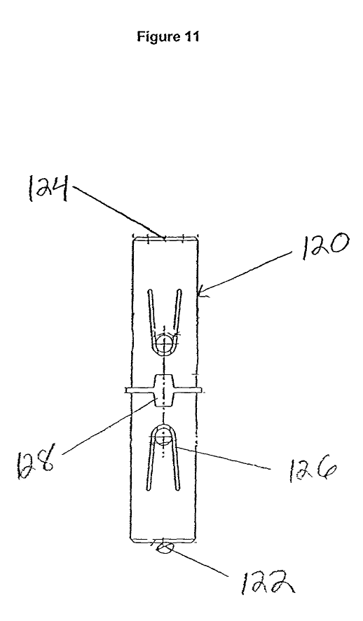

Referring to FIG. 11, each one-piece cylindrical connector 120 has bottom and top ends 122 and 124 which are inserted into an open end of each individual frame member, as shown in FIG. 11, in order to attach each individual frame member to another frame member utilizing the connector. For attachment to each of the individual frame members, snap-in pins 126 extend outwardly from the outer surface of the connector. Additionally, the connector 120 has an outwardly extending segment 128 extending around a portion of its outer surface, which is received in a corresponding cut-out segment-receiving pocket at the end of each individual frame member, aiding in aligning the connector 120 with each individual frame member in order to snap each pin 126 into place within a corresponding pin-receiving socket in each individual frame member 20, 30, 40, and 50, thereby securely connecting each end of the connector 122 and 124 to an end of an individual frame member.

In the preferred embodiment, as shown in FIG. 1, to attach the flexible screen 100 to the individual frame members 20, 30, 40, and 50, each of the individual frame members are inserted within a separately sewn end-pocket 110 running along each end of the screen's periphery. After insertion, each end of each individual frame member extends out of a separate corresponding end of each sewn end-pocket into a cut away portion 130 of the screen 100. The connectors 120 are then inserted within the ends of each individual frame member at the cutaway portions 130 of the screen 100 in order to form a continuous frame 14 around the periphery of the screen. The cut-away portions of the screen 130 act as handles around the periphery of the screen allowing the frame 14 to be gripped in order to move the privacy screen 10. Alternatively, a member which is preferably steel but which may be a variety of other materials including plastic, may be attached to the support frame to act as a handle.

The privacy screen 10 may be moved from one position to a second position by removing one end of the frame 14 from the ground and moving a second end of the frame to another position at which point the removed end of the frame is re-engaged with the ground.

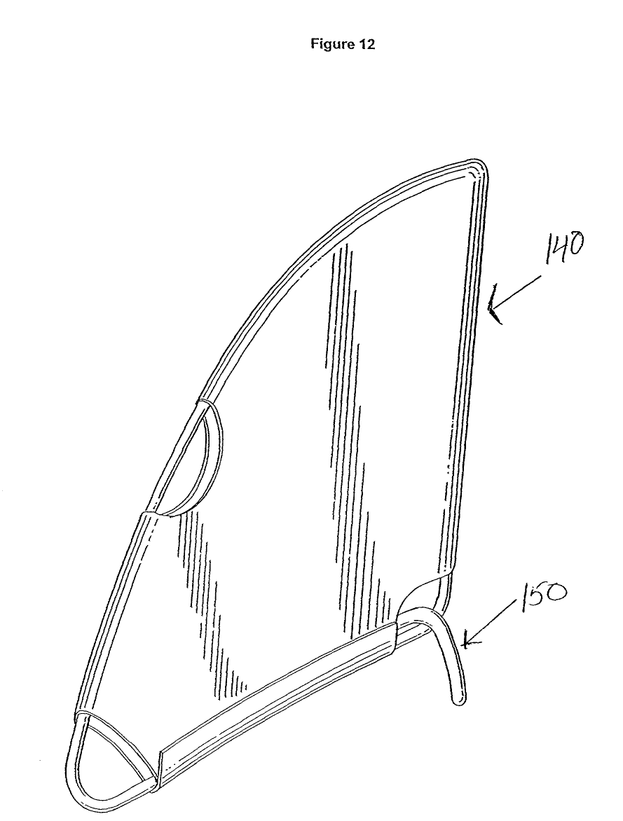

Although wheels are included in the preferred embodiment, they are not a necessary component of the invention as shown in FIG. 12 in which a second embodiment of a privacy screen 140 having outriggers 150 but lacking wheels is shown.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A privacy screen comprising:
a support frame defining an opening;
a screen member made of a flexible material, wherein said screen member is disposed across said opening and is attached to said support frame at a periphery of said screen member; and
an outrigger extending from said support frame and having an end adapted to engage a support surface.

2. The invention of claim 1 further comprising a wheel attached to said end of said outrigger.

3. The invention of claim 1 wherein said support frame further comprises a handle.

4. The invention of claim 1 further comprising a member attached to said support frame to act as a handle.

5. The invention of claim 1 wherein said support frame has a first end and a second end, wherein said outrigger is attached to said first end and wherein said second end comprises a handle.

6. The invention of claim 1 wherein said screen member has an opening formed along a portion of the periphery thereof so as to expose a portion of said frame, wherein said exposed portion of said frame defines a handle.

7. The invention of claim 1 wherein said support frame and said screen member define a substantially vertical plane, and wherein said outrigger extends laterally from said support frame out of said plane.

8. The invention of claim 1 wherein said support frame comprises a plurality of frame members extending around a periphery of said frame and defining said opening therebetween.

9. A method of reconfiguring a workspace comprising:
providing a privacy screen comprising a support frame defining an opening and comprising a first end and a second end, a screen member made of a flexible material, wherein said screen member is disposed across said opening and is attached to said support frame at a periphery of said screen member, and an outrigger extending from said first end of said support frame and having an end engaged with a support surface, wherein said second end of said frame is engaged with said support surface;
removing said second end of said support frame from said engagement with said support surface;
moving said end of said outrigger on said support surface from a first location to a second location; and
engaging said support surface with said second end of said support frame.

10. The invention of claim 9 wherein said outrigger further comprises a wheel connected to said end thereof, wherein said moving said end of said outrigger comprises rolling said wheel on said support surface.

11. The invention of claim 9 wherein said screen member has an opening formed along a portion of the periphery thereof so as to expose a portion of said frame, wherein said exposed portion of said frame defines said handle, and wherein said removing said second end of said support frame comprises grasping said handle and lifting said second end of said support frame from said engagement with said support surface.

12. The invention of claim 9 wherein said support frame and said screen member define a substantially vertical plane, and wherein said outrigger extends laterally from said support frame out of said plane.

13. The invention of claim 9 further comprising a member attached to said support frame to act as a handle.
